(19) United States
(12) Patent Application Publication
(10) Pub. No.: US 2016/0092845 A1
(43) Pub. Date: Mar. 31, 2016

(54) SYSTEM AND METHOD FOR EFFICIENT SCHEDULING OF CLIENT APPOINTMENTS

(71) Applicant: The Cooper Health System, a New Jersey Nonprofit Corporation, Camden, NJ (US)

(72) Inventor: Jonathan Vogan, Philadelphia, PA (US)

(21) Appl. No.: 14/863,565

(22) Filed: Oct. 8, 2015

Related U.S. Application Data
(60) Provisional application No. 62/056,811, filed on Sep. 29, 2014.
(60) Provisional application No. 62/198,182, filed on Jul. 29, 2015.

(51) Int. Cl. G06Q 10/10

(52) U.S. Cl. CPC G06Q 10/1095

(57) ABSTRACT

A system and method for the efficient scheduling of client appointments is provided. Specifically, the system and method of the instant invention analyzes data points attributable to specific scheduled patients in order to predict the overall workload for service providers in a given period and then, if appropriate, recommendations are made for adding additional appointments to a schedule in an optimal manner in order to align the number of clients to be seen with the number of appointment slots available.

### CROSS REFERENCE TO RELATED APPLICATION(S)

This application claims the benefit of U.S. Provisional Application No. 62/056,811, filed Sep. 29, 2014 and U.S. Provisional Application No. 62/198,182, filed Jul. 29, 2015.

### FIELD OF THE INVENTION

The present invention relates in general to computer implemented appointment scheduling and, more specifically, determining the likelihood of whether particular patients will arrive on time for their scheduled appointments and optimizing scheduling based on this information.

### BACKGROUND OF THE INVENTION

Appointments scheduled with medical providers are sometimes broken. When an appointment is broken with little or no notice, it can leave the provider without a patient, which results in no revenue to the provider for that period of time. It is possible to compensate for this problem by scheduling more patients than can actually be seen, but this creates the risk of having a patient arrive and either be denied service or made to wait for an extended period of time. Neither outcome is optimal. Additionally, this strategy may result in overtime expenses for the medical provider and his or her office support staff.

Some medical offices seek to reduce broken appointments by applying one or more strategies. A first strategy involves assessing a charge to a patient for each broken appointment. This approach is difficult to enforce when the patient is new to the practice. The approach is also difficult to enforce since it is not compliant with many government-funded health insurance policies, such as Medicaid. As both new patients and patients on government-funded health insurance are more likely to break their appointments, this strategy has limited effectiveness.

A second strategy, as previously mentioned, involves scheduling more patients than can actually be seen. This addresses the economic consequences to the provider for broken appointments, but it can result in very long waiting times and frustrated patients. Furthermore, this approach does nothing to address the underlying uncertainty. Rather, it amplifies it.

A need, therefore, exists in the art to reduce the uncertainty surrounding whether an individual patient will arrive to their appointment. A further need exists in the art to accurately anticipate the total number of patients expected to arrive for a given session.

### SUMMARY OF THE INVENTION

According to the present invention, the foregoing and other objects and advantages are obtained by using a method for optimizing scheduled attendance. The method comprises the steps of collecting data points, processing the data points using an online stochastic gradient descent optimizer, utilizing latent dirichlet allocation to reduce dimensionality, setting regularization, validating the accuracy of predictions with a receiver operator curve, performing discrete event simulation, aggregating each event simulation into an empirical distribution of simulated workload with an output supplied to a gradient tree boosting machine learning algorithm, and adding an additional appointment within an optimally determined time slot if a resulting prediction of the total workload for a given session indicates underutilization.

According to another aspect of the invention, there is an improved computer-implemented system for scheduling appointments with a service provider, with an steps comprising collecting data points, utilizing a dedicated terminal for displaying recommendations for modifications to an appointment schedule based on the collection of data points, processing the data points using an online stochastic gradient descent optimizer, utilizing latent dirichlet allocation to reduce dimensionality, setting regularization, validating the accuracy of predictions with a receiver operator curve, performing discrete event simulation, aggregating each said event simulation into an empirical distribution of simulated workload with an output supplied to a gradient tree boosting machine learning algorithm, and adding an additional appointment within an optimally determined time slot if a resulting prediction of the total workload for a given session indicates underutilization, as depicted on the terminal.

### BRIEF DESCRIPTION OF THE DRAWINGS

The invention will become more readily apparent from the following description of preferred embodiments thereof shown, by way of example only, in the accompanying drawings wherein:

FIG. 1 is a diagram that illustrates a problem found in the prior art.

FIG. 2 is a diagram that illustrates a common consequence for a solution to the problem illustrated in FIG. 1, along with a solution to the problem using an aspect of the instant invention.

FIG. 3 is a flowchart describing the steps for carrying out a method of the instant invention according to one embodiment of the invention.

### DETAILED DESCRIPTION OF THE INVENTION

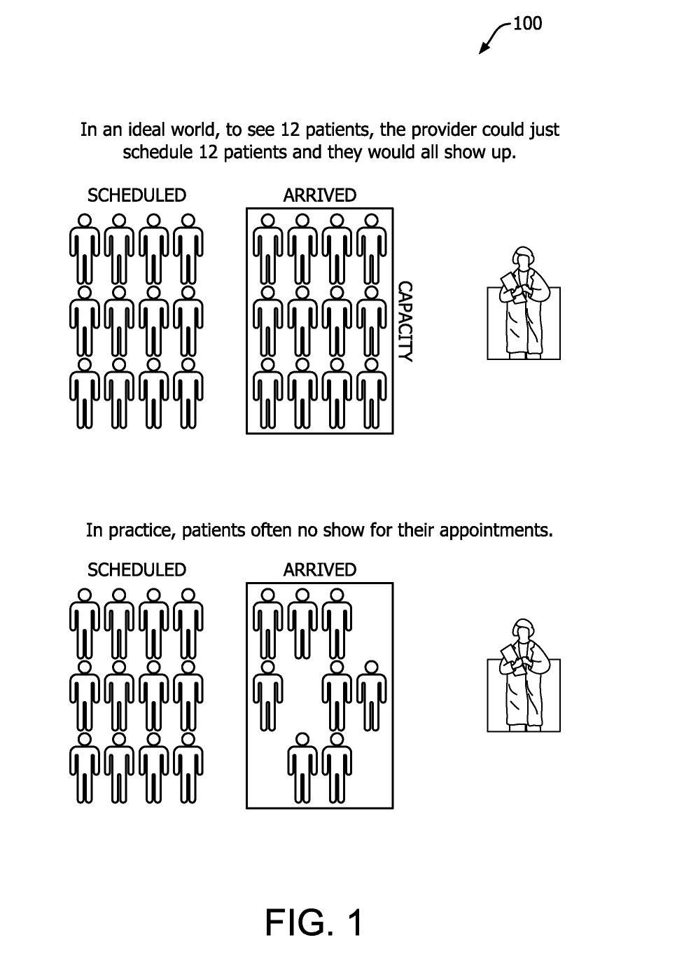

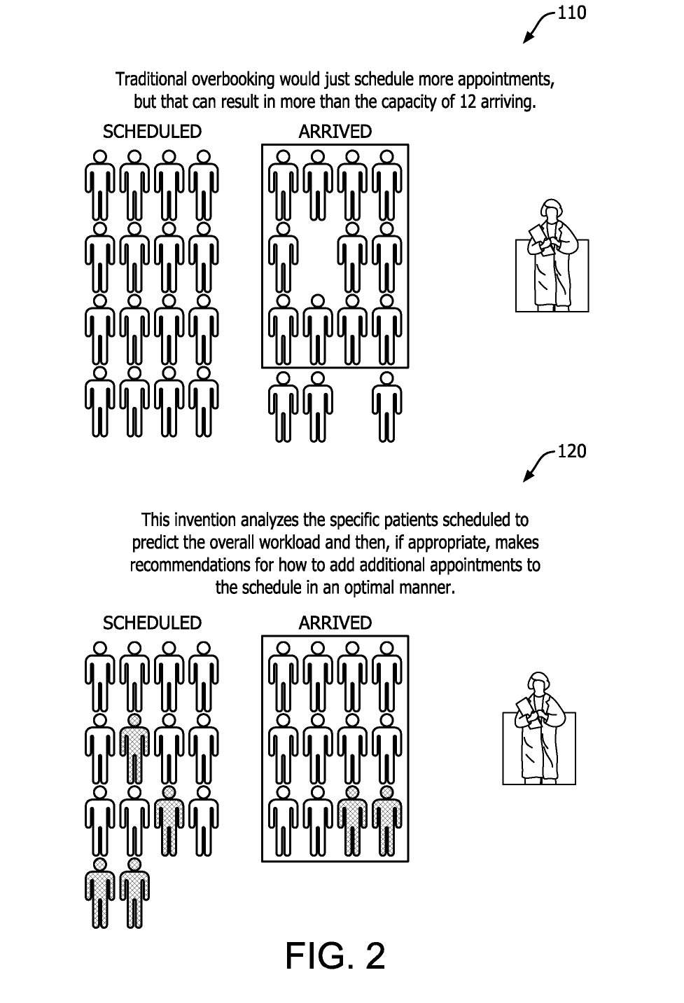

FIG. 1, as generally shown by reference number 100, illustrates the a problem the system of the instant invention is directed to solve, namely that patients will not always attend their scheduled appointments. FIG. 2, as generally shown by reference number 110, illustrates a common problem arising as a consequence of overbooking as a solution to the aforementioned problem, yet this approach often results in over-capacity. As illustrated by reference numeral 120, one aspect of the system of the instant invention works to analyze the specific patients scheduled in order to predict the overall workload and then, if appropriate, the system makes recommendations for how to add additional appointments to the schedule in an optimal manner.

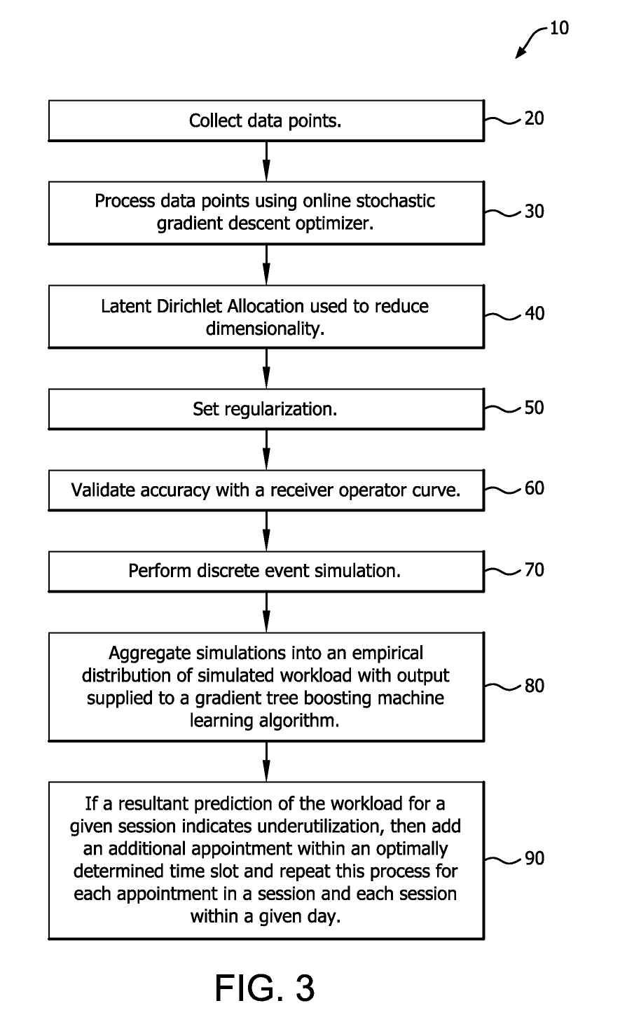

The computer-implemented system and method of the instant invention operates in three primary stages (1) predicting the likelihood of whether an appointment will be broken, (2) predicting the session workload, and (3) recommending modifications to appointments scheduled during a session. Each of these stages and their respective steps are illustrated on the flowchart shown on FIG. 3, generally identified by reference number 10.

The first stage collects several data points, as indicated at step 20, which may include any or all of the following by way of a non-limiting example: patient demographics (gender, age, marital status, employment status, race, and/or spoken language), appointment details (date of appointment, date the appointment was scheduled, time between the date of scheduling and the date of the appointment, the provider, the provider's medical specialty, the location of the appointment, the time of day, the duration of the appointment, whether the appointment was constrained by capacity, day of the year, and/or reason for the visit), a patient's history (attendance history within the entire health system with respect to a given provider, a given location and including the attendance rate of past appointments and/or the time since the last appointment), automated reminder call response (whether the call/e-mail/text was successful, whether the patient listened to or otherwise received the reminder, whether the patient responded to the reminder, and if the patient responded, what was the response), and/or the patient diagnosis and procedural history, as represented by 5-digit ICD9 and CPT codes, respectively.

The above-referenced data points are then used as input into a machine learning algorithm, logic regression, using an online stochastic gradient descent optimizer, as shown at step 30. A detailed description of the tool used to implement this algorithm is described in the following website https://github.com/JohnLangford/vowpal_wabbit/wiki and in the following references, each of which are incorporated herein by reference:

### Kilian Weinberger, Anirban Dasgupta, John Langford, Alex Smola, Josh Attenberg, Feature Hashing for Large Scale Multitask Learning, ICML 2009.

### A. Agarwal, O. Chapelle, M. Dudik, and J. Langford, “A Reliable Effective Terascale Linear Learning System,” Journal of Machine Learning Research, vol. 15, pp. 1111-1133, 2014.

Logistic regression is a very mature algorithm for predicting binary outcomes, such as whether a patient will arrive for his or her appointment. The use of a stochastic gradient descent algorithm makes it possible to train the algorithm on much larger amounts of data than would otherwise be possible. This is because the algorithm is “online,” meaning that it uses the data, one observation at a time, unlike traditional “batch” machine learning algorithms which must consider all of the data at once. Using the data observation-by-observation, results in the amount of data not being constrained by the amount of RAM on a given machine. This makes the algorithm capable of handling practically unlimited amounts of data. In the context of predicting appointment breakage, this makes it possible to use many more appointments to train the model as well as to use a much richer set of variables to predict each appointment than would be the case with a batch learning algorithm.

The specific implementation for this solution requires several parameters to be set. Within one embodiment of the instant invention, 5 digit ICD9 codes are mapped into 20 topics using a Latent Dirichlet Allocation (LDA) model in order to reduce the dimensionality of the diagnosis history, as shown at step 40. Within the same embodiment of the instant invention, regularization, which prevents the model from overfitting to the training data, was set at 10̂−8 for L1 regularization and 10̂−7 for L2 regularization, as shown at step 50. While logistic regression is a linear algorithm, interactions between certain groups of variables were added in this embodiment. Specifically, the specialty of the provider being seen was interacted with the patient demographics, automated call responses, attendance history, procedural history and diagnosis history.

The above-stated parameters were found to be optimal for the particular circumstances of a particular hospital. This assessment was made by experimentation and evaluation of the predictive accuracy, as measured by the receiver operator curve for out-of-sample predictions, as shown at step 60. Receiver-operator curves are standard tools for assessing the accuracy of a prediction of a binary outcome, which captures the trade-off between false positives and false negatives. Applications of this solution to other settings would require that these parameters be re-calculated through similar experimentation in order to ensure the optimal outcome for that setting. By way of example, with these parameters, a single model can be fit for each of ten working days prior to a scheduled appointment.

Using the predictions from the first step, repeated random simulations are then conducted for every session being predicted. This is done using a technique known as discrete event simulation, as shown at step 70. Using the calculated appointment-level predictions from the first step, 100 simulated sessions are run, according to one embodiment of the instant invention, with each appointment showing up at random in each simulation based on its calculated prediction.

Such simulations are then aggregated into an empirical distribution of the simulated workload, measured in minutes, as shown at step 80. The quantiles from this distribution, together with other information regarding the session, duration, unbooked time, and total scheduled appointment time are then used as inputs into a gradient tree boosting machine learning algorithm. Gradient tree boosting is described in detail in the following journal articles, each of which are incorporated herein by reference:

### J.H. Friedman (2001). “Greedy Function Approximation: A Gradient Boosting Machine,” Annals of Statistics 29(5): 1189-1232.

### J.H. Friedman (2002). “Stochastic Gradient Boosting,” Computational Statistics and Data Analysis 38(4): 367-378.

Gradient tree boosting is utilized in the preferred embodiment as it is widely regarded as a superior machine learning algorithm. By way of example, specific parameters used for one embodiment of the model include the following: (1) the number of trees were set to minimize the out-of-bag error rate; (2) the interaction depth of each tree was set to 15, with a minimum of 10 observations at every node; (3) the learning rate was set at 0.01, and; (4) the model was trained to separately predict the 10^{th} and 90^{th} percentile of the actual total duration of the arrived patients for each session.

Applications of this solution to other settings would require that these parameters be re-calculated through similar experimentation to ensure the optimal outcome for that setting. With these parameters established, models are fit for each forecast horizon—from same-day to 2 weeks in advance.

The final of the three steps results in session change recommendations, as shown in step 90. Using the predictions for the actual workload for each session, those sessions predicted, with 90% confidence, to be under-utilized are analyzed for the optimal opportunity to add additional appointments within a session. The level of 90% confidence is only intended to serve as an example. Other levels of confidence can be selected, as desired.

The search for optimal times to add each appointment works using a greedy, exhaustive search of each five (5) minute time slot in a session. For sessions with appointment types of varying duration, the search can be run, according to one embodiment of the instant invention, for the two most common durations and both sets of recommendations are returned by the system of the instant invention. The search algorithm works by taking the currently scheduled appointments, their scheduled start times, their durations, and their predicted likelihood of having a patient showing up. It then looks at each five minute block of time in the session and selects the block of time where the expected number of patients is the lowest. According to one embodiment of the instant invention, the system of the instant invention then adds one (1) appointment to that block, extending for the assigned duration. The process is then repeated for each additional appointment to be added, with subsequent searches also considering the appointments added by prior iterations. A dedicated terminal is utilized, in one embodiment of the instant invention, for the purpose of visualizing the appointment schedule.

Advantageously, the system of the instant invention uses an online implementation of logistic regression. This process makes it feasible to learn from potentially hundreds of millions of appointments, such as would exist in the very largest of healthcare systems. It also makes it possible to use much larger amounts of data for each observation. For example, free form text (i.e. the reason for the patient's visit) and 5-digit ICD codes (or CPT codes) are used, along with other data, to predict patient attendance according to at least one embodiment of the instant invention.

It is understood that the particular embodiment of the invention disclosed herein pertains to an outpatient medical office setting. However, it should be understood that the system of the instant invention has potential applications to any situation where there is a schedule used to manage the utilization of a resource that becomes worthless if it is not used for a period of time. Such examples include, airlines, hotels, restaurants that take reservations, dentist offices, daycare centers, car rental agencies, and live entertainment venues—among others. Settings where there are repeated interactions with identifiable individuals are most likely to benefit from the system of the instant invention, though this is not an absolute requirement.

What is claimed is:

1. A method for optimizing scheduling of appointments comprising the steps of:
collecting data points;
processing said data points using an online stochastic gradient descent optimizer;
utilizing latent dirichlet allocation to reduce dimensionality;
setting regularization;
validating the accuracy of predictions with a receiver operator curve;
performing discrete event simulation;
aggregating each said event simulation into an empirical distribution of simulated workload with an output supplied to a gradient tree boosting machine learning algorithm; and
adding an additional appointment within an optimally determined time slot if a resulting prediction of the total workload for a given session indicates underutilization.

2. A computer-implemented system for scheduling appointments with a service provider, the improvement comprising:
collecting data points;
utilizing a dedicated terminal for displaying recommendations for modifications to an appointment schedule based on the collection of data points;
processing said data points using an online stochastic gradient descent optimizer;
utilizing latent dirichlet allocation to reduce dimensionality;
setting regularization;
validating the accuracy of predictions with a receiver operator curve;
performing discrete event simulation;
aggregating each said event simulation into an empirical distribution of simulated workload with an output supplied to a gradient tree boosting machine learning algorithm; and
adding an additional appointment within an optimally determined time slot if a resulting prediction of the total workload for a given session indicates underutilization, as depicted on the said terminal.
